(19) United States
(12) Patent Application Publication
(10) Pub. No.: US 2018/0147737 A1
(43) Pub. Date: May 31, 2018

(54) CUTTING DEVICE AND SCISSORS

(71) Applicant: SEIKO INSTRUMENTS INC., Chiba-shi, Chiba (JP)

(72) Inventors: Makoto SUZUKI, Chiba-shi, Chiba (JP); Kazuyoshi FURUTA, Chiba-shi, Chiba (JP); Akihiro IINO, Chiba-shi, Chiba (JP); Jun SHINOHARA, Chiba-shi, Chiba (JP)

(21) Appl. No.: 15/579,548

(22) PCT Filed: Jun. 16, 2016
(86) PCT No.: PCT/JP2016/067917

§ 371 Date: Dec. 4, 2017

(30) Foreign Application Priority Data
Jul. 6, 2015 (JP) 2015-135495

(51) Int. Cl. B26B 13/28

(52) U.S. Cl. CPC B26B 13/285

(57) ABSTRACT

A cutting device includes a support shaft; a first blade body which holds the support shaft; a rolling bearing which is mounted on the support shaft, and has an outer race and an inner race; a second blade body which is provided to overlap the first blade body, and is rotatably supported on the support shaft via the rolling bearing; a fixing member which is disposed on the support shaft on a side opposite to the first blade body across the rolling bearing; and a biasing member disposed between the rolling bearing and the fixing member. One of the outer race and the inner race rotates integrally with the second blade body, and the other of the outer race and the inner race is biased toward the first blade body by the biasing member.

### TECHNICAL FIELD

The present invention relates to a cutting device and scissors.

Priority is claimed on Japanese Patent Application No. 2015-135495, filed Jul. 6, 2015, the content of which is incorporated herein by reference.

### BACKGROUND ART

For example, scissors are adopted as a tool having a cutting device. Scissors include a pair of blade bodies, and a support shaft which supports the pair of blade bodies (see, for example, Patent Document 1). In the scissors, one blade body is slidably supported on the support shaft.

### CITATION LIST

### Patent Literature

### [Patent Document 1]

Japanese Unexamined Utility Model application, First Publication No. H07-5564

### SUMMARY OF INVENTION

### Technical Problem

However, with the scissors including the aforementioned conventional cutting device, there are cases in which the support shaft wears due to sliding between the support shaft and the blade bodies supported by the support shaft, which causes rattling of the blade bodies. In this case, since a gap is formed between the pair of blade bodies to deteriorate meshing, there is a possibility of degradation of the cutting performance.

The present invention provides a cutting device and scissors capable of maintaining excellent cutting performance.

### Solution to Problem

A cutting device according to a first aspect of the present invention includes: a support shaft; a first blade body which holds the support shaft; a rolling bearing which is mounted on the support shaft, and has an outer race and an inner race; a second blade body which is provided to overlap the first blade body, and is rotatably supported on the support shaft via the rolling bearing; a fixing member which is disposed on the support shaft on a side opposite to the first blade body across the rolling bearing; and a biasing member disposed between the rolling bearing and the fixing member. One of the outer race and the inner race rotates integrally with the second blade body, and the other of the outer race and the inner race is biased toward the first blade body by the biasing member.

With such a configuration, since one of an outer race and an inner race of a rolling bearing rotates together with a second blade body, and the other is biased toward a first blade body by the biasing member, the second blade body can be pressed toward the first blade body. Thus, the first blade body and the second blade body are always in pressure-contact with each other, and the cutting performance can be maintained. In addition, since the one of the outer race and the inner race that rotates integrally with the second blade body does not come into contact with the biasing member, an increase in sliding friction at the time of rotation can be suppressed. Therefore, the movement of the first blade body and the second blade body can be made smooth. Therefore, it is possible to provide a cutting device capable of maintaining excellent cutting performance.

According to a second aspect of the present invention, in the cutting device according to the first aspect of the present invention, the outer race may rotate integrally with the second blade body, and the inner race may be biased toward the first blade body by the biasing member.

With such a configuration, since the outer race rotates integrally with the second blade body, the rolling bearing and the second blade body can be provided at the same axial position of the support shaft. Therefore, the structures of the rolling bearing and the biasing member can be simplified, the dimensions including the first blade body, the second blade body, and the rolling bearing can be reduced in the axial direction of the support shaft, and the cutting device can be made thin.

According to a third aspect of the present invention, in the cutting device according to the second aspect of the present invention, the second blade body may include a bearing holding hole, the outer race being fixed to the bearing holding hole, the outer race may include a flange portion protruding outward in a radial direction on an outer peripheral edge of the outer race opposite to the first blade body, and a counterbore portion which receives the flange portion may be formed on the bearing holding hole.

With such a configuration, by the abutment between the flange portion of the outer race and the counterbore portion of the bearing holding hole, displacement of the rolling bearing toward the first blade body side can be regulated to press the second blade body by the biasing member. Further, as the counterbore portion receives the flange portion, the dimension including the second blade body and the rolling bearing in the axial direction of the support shaft can be reduced. Therefore, the cutting device can be made thin.

According to a fourth aspect of the present invention, in the cutting device according to the third aspect of the present invention, one end portion of the rolling bearing on the first blade body side in the axial direction of the support shaft may protrude from a surface of the second blade body facing the first blade body toward the first blade body, and on a surface of the first blade body facing the second blade body, a recess may be formed which is open to the second blade body in the axial direction to receive the one end portion of the rolling bearing.

With such a configuration, even when the one end portion on the first blade body side of the rolling bearing protrudes from the second blade body due to the thinning of the second blade body, the first blade body and the second blade body can be made to overlap each other. Therefore, the cutting device can be made thin.

Further, since the rolling bearing can be increased in dimension without increasing the thickness of the cutting device, each blade body can be moved more smoothly.

According to a fifth aspect of the present invention, in the cutting device according to the second aspect of the present invention, the outer peripheral surface of the outer race may be uniformly formed in the axial direction of the support shaft, the second blade body may include a bearing holding recess which is open to the fixing member side in the axial direction, the outer race being fixed to the bearing holding recess, and a dimension of the bearing holding recess in the axial direction may be equal to or larger than a dimension of the rolling bearing in the axial direction.

With such a configuration, by causing the rolling bearing to abut against the bottom portion of the bearing holding recess, it is possible to completely house the rolling bearing in the bearing holding recess, while enabling the second blade body to be pressed by the biasing member by restricting the displacement of the rolling bearing toward the first blade body. As a result, it is possible to reduce the dimension including the second blade body and the rolling bearing in the axial direction. Therefore, the cutting device can be made thin.

According to a sixth aspect of the present invention, in the cutting device according to the second aspect of the present invention, the outer peripheral surface of the outer race may be uniformly formed in the axial direction of the support shaft, the second blade body may include a bearing holding hole, the outer race being fixed to the bearing holding hole, and the bearing holding hole may be uniformly formed in the axial direction.

With such a configuration, since the bearing holding hole is formed uniformly in the axial direction of the support shaft, the bearing holding hole can be easily formed by press-machining or the like. Therefore, the second blade body can be manufactured at a low cost. Moreover, since the outer race of the rolling bearing is fixed to the bearing holding hole, the second blade body can be pressed by the biasing member by regulating the displacement of the rolling bearing toward the first blade body side, while preventing the rolling bearing from falling out of the bearing holding hole. Therefore, the cutting device capable of maintaining excellent cutting performance can be provided at a low cost.

According to a seventh aspect of the present invention, in the cutting device according to any one of the first to sixth aspects of the present invention, a sliding member may be provided at a position where the first blade body and the second blade body always face each other.

With such a configuration, it is possible to reduce the sliding resistance between the first blade body and the second blade body by the sliding member. Therefore, the movement of the first blade body and the second blade body can be made smooth.

According to an eighth aspect of the present invention, in the cutting device according to the seventh aspect of the present invention, the sliding member may be provided on the first blade body and the second blade body on a side closer to a proximal end than the support shaft, and may bias the first blade body and the second blade body away from each other.

With such a configuration, the sliding member is provided on the first blade body and the second blade body on the side closer to the proximal end than the support shaft, and biases the first blade body and the second blade body away from each other. Thus, the distal end sides of the first blade body and the second blade body can be brought close to each other with the support shaft as a fulcrum. Accordingly, the blade lines provided on the distal end sides of the first blade body and the second blade body can be always pressed against each other, and the cutting performance can be improved.

According to a ninth aspect of the present invention, in the cutting device according to any one of the first to eighth aspects of the present invention, a rotation stop portion may be provided on at least one of the first blade body and the support shaft to prevent relative rotation between the first blade body and the support shaft.

With such a configuration, when the fixing member is mounted on the support shaft while supporting the first blade body, it is possible to prevent the support shaft from rotating with respect to the first blade body by the rotation stop portion. Therefore, the fixing member can be easily attached to and detached from the support shaft, and disassembly and assembly of the first blade body and the second blade body can be easily performed.

According to a tenth aspect of the present invention, in the cutting device according to any one of the first to ninth aspects of the present invention, a groove may be formed on an end surface of the support shaft on the side of first blade body in the axial direction of the support shaft.

With such a configuration, it is possible to fix the support shaft by inserting a driver or the like into the groove. Thus, the fixing member can be easily attached to and detached from the support shaft, and disassembly or assembly of the first blade body and the second blade body can be easily performed.

Scissors according to an eleventh aspect of the present invention include the cutting device according to any one of the first to tenth aspects; a first gripping portion provided on the proximal end side of the first blade body; and a second gripping portion provided on the proximal end side of the second blade body.

According to the above configuration, since the scissors have the above-described cutting device, excellent cutting performance can be maintained.

### Advantageous Effects of Invention

According to the cutting device of each aspect, since one of an outer race and an inner race of a rolling bearing rotates together with a second blade body, and the other is biased toward a first blade body by the biasing member, the second blade body can be pressed toward the first blade body. For this reason, the first blade body and the second blade body are always in pressure-contact with each other, and the cutting performance can be maintained. In addition, since one of the outer race and the inner race that rotates integrally with the second blade body does not come into contact with the biasing member, an increase in sliding friction at the time of rotation can be suppressed. Therefore, the movement of the first blade body and the second blade body can be made smooth. Further, the same effect can be obtained in the scissors equipped with the cutting device.

Therefore, according to each of the above aspects of the present invention, it is possible to provide a cutting device and scissors capable of maintaining excellent cutting performance.

### BRIEF DESCRIPTION OF DRAWINGS

FIG. 1 is a plan view of scissors according to a first embodiment of the present invention.

FIG. 2 is a cross-sectional view taken along a line II-II of FIG. 1.

FIG. 3 is a plan view of a first blade body of the scissors according to the first embodiment.

FIG. 4 is a plan view of a second blade body of scissors according to the first embodiment.

FIG. 5 is a plan view of a support shaft of the scissors according to the first embodiment.

FIG. 6 is an explanatory view showing a modified example of the biasing member, and is a cross-sectional view of a portion corresponding to the line II-II of FIG. 1.

FIG. 7 is an explanatory view of scissors according to a second embodiment of the present invention, and is a cross-sectional view of a portion corresponding to the line II-II of FIG. 1.

FIG. 8 is a plan view of scissors according to a third embodiment of the present invention in a closed state.

FIG. 9 is a plan view of scissors according to the third embodiment in an open state.

FIG. 10 is a cross-sectional view taken along a line X-X of FIG. 8.

FIG. 11 is an explanatory view of scissors according to a fourth embodiment of the present invention, and is a cross-sectional view of a portion corresponding to the line X-X of FIG. 8.

FIG. 12 is an explanatory view of scissors according to a fifth embodiment of the present invention, and is a cross-sectional view of a portion corresponding to the line X-X of FIG. 8.

FIG. 13 is an explanatory view of scissors according to a sixth embodiment of the present invention, and is a cross-sectional view of a portion corresponding to the line X-X of FIG. 8.

FIG. 14 is a plan view of a first blade body of scissors according to a seventh embodiment of the present invention.

FIG. 15 is a plan view of the support shaft of the scissors according to the seventh embodiment.

FIG. 16 is a side view of the support shaft of the scissors according to the seventh embodiment.

FIG. 17 is an explanatory view of scissors according to an eighth embodiment of the present invention, and is a cross-sectional of a portion corresponding to a line II-II of FIG. 1.

### DESCRIPTION OF EMBODIMENTS

Hereinafter, each embodiment of the present invention will be described on the basis of the drawings.

### First Embodiment

First, scissors 1 (a cutting device) of the first embodiment will be described.

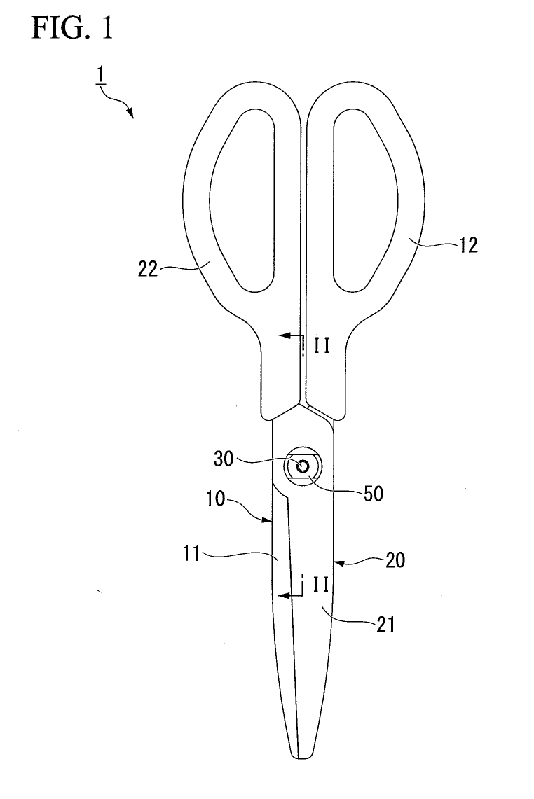

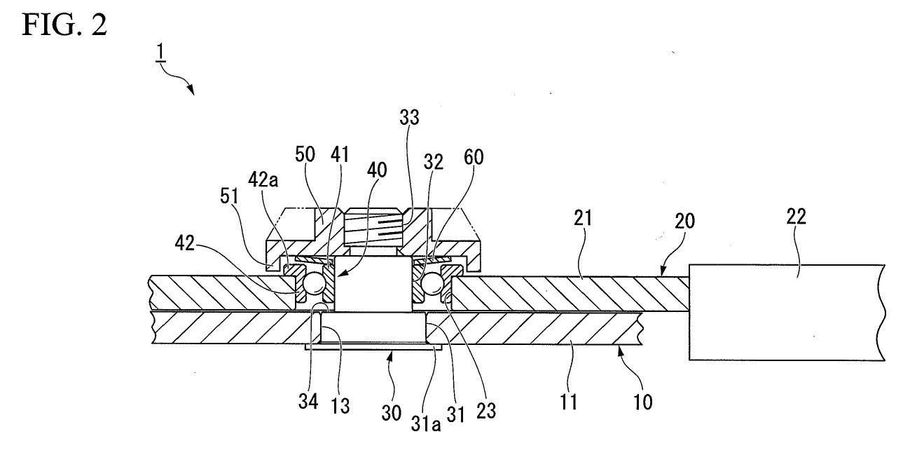

FIG. 1 is a plan view of the scissors according to the first embodiment. FIG. 2 is a cross-sectional view taken along a line II-II of FIG. 1.

As shown in FIGS. 1 and 2, the scissors 1 are so-called western-style scissors. The scissors 1 include a first blade body 10 which holds a support shaft 30, and a second blade body 20 provided to overlap the first blade body 10 and rotatably supported on the support shaft 30 via a rolling bearing 40. The first blade body 10 and the second blade body 20 are curved to gradually approach each other from the support shaft 30 toward a tip. In the following description, in an axial direction of the support shaft 30 (hereinafter simply referred to as “axial direction”), the side of the second blade body 20 as viewed from the first blade body 10 is referred to as an upper side, and an opposite side thereof is referred to as a lower side.

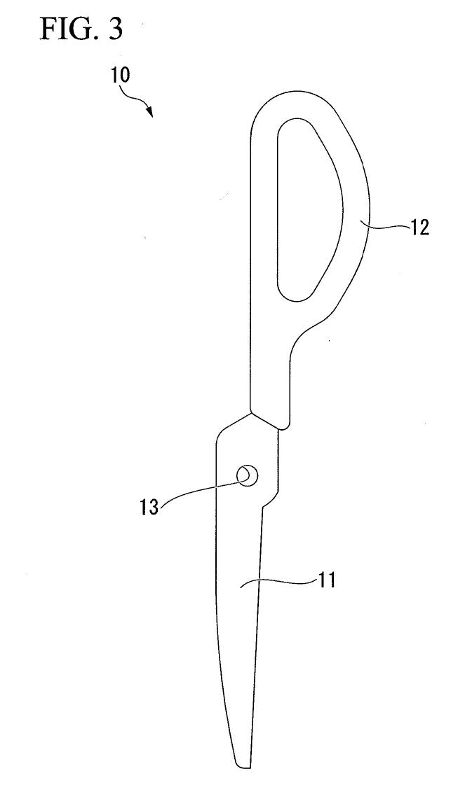

FIG. 3 is a plan view of the first blade body of the scissors according to the first embodiment.

As shown in FIG. 3, the first blade body 10 includes a first base body 11 formed of a metal plate having a thickness in the axial direction, and a first gripping portion 12 attached to the proximal end portion of the first base body 11. A blade line is formed on the first base body 11. The upper surface of the first base body 11 is formed in a planar shape. A support shaft insertion hole 13 through which the support shaft 30 (see FIG. 2) is inserted is formed in the first base body 11. The support shaft insertion hole 13 is formed in a circular shape when viewed in a cross section and penetrates the first base body 11 with a constant inner diameter in the axial direction. The first gripping portion 12 is provided on a proximal end side of the first blade body 10. The first gripping portion 12 is formed in a ring shape, for example, of a resin material or the like.

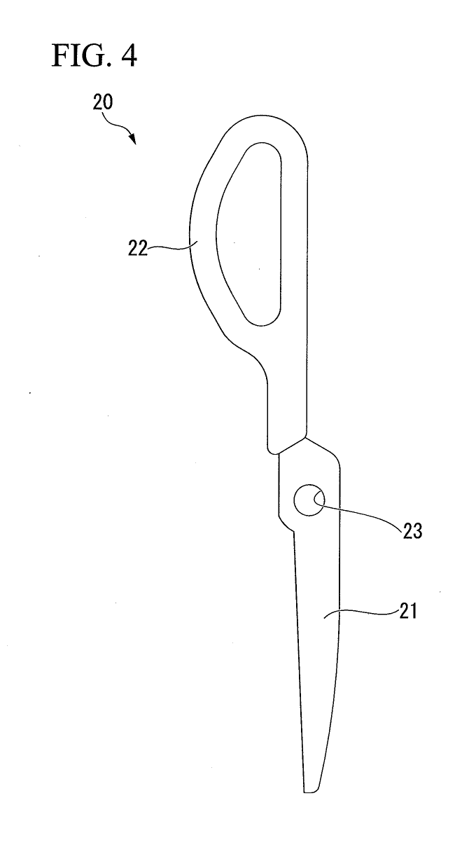

FIG. 4 is a plan view of the second blade body of the scissors according to the first embodiment.

As shown in FIG. 4, the second blade body 20 includes a second base body 21 formed of a metal plate having a thickness in the axial direction, and a second gripping portion 22 attached to the proximal end portion of the second base body 21. A blade line is formed on the second base body 21. The lower surface of the second base body 21 is formed in a planar shape. A bearing holding hole 23 into which the rolling bearing 40 (see FIG. 2) is press-fitted is formed in the second base body 21. The bearing holding hole 23 is formed in a circular shape when viewed in a cross section and penetrates the second base body 21 with a constant inner diameter in the axial direction. The inner diameter of the bearing holding hole 23 is set to be larger than the inner diameter of the support shaft insertion hole 13 (see FIG. 3). The second gripping portion 22 is provided on the proximal end side of the second blade body 20. The second gripping portion 22 is formed in a ring shape, for example, of a resin material or the like.

As shown in FIG. 2, the support shaft 30 is press-fitted into the support shaft insertion hole 13 of the first blade body 10. The support shaft 30 includes a large-diameter portion 31 formed at the lower end portion, a small-diameter portion 32 connected to the upper end of the large-diameter portion 31, and a male screw portion 33 which is smaller in diameter than the small-diameter portion 32 and connected to the upper end of the small-diameter portion 32. The large-diameter portion 31, the small-diameter portion 32, and the male screw portion 33 are coaxially disposed.

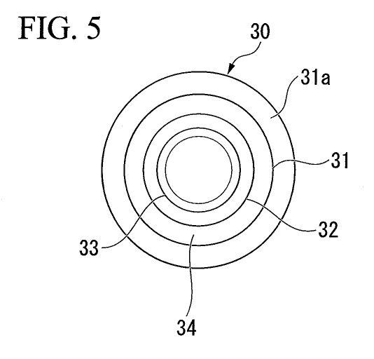

FIG. 5 is a plan view of the support shaft of the scissors according to the first embodiment.

As shown in FIGS. 2 and 5, the large-diameter portion 31 is formed in a circular shape when viewed in a cross section, and is press-fitted into the support shaft insertion hole 13. An outer flange portion 31a is formed at a lower end portion of the large-diameter portion 31. The upper surface of the outer flange portion 31a abuts on the lower surface of the first base body 11. A stepped surface 34 between the large-diameter portion 31 and the small-diameter portion 32 is flush with the upper surface of the first base body 11.

The small-diameter portion 32 is formed in a circular shape when viewed in a cross section. The upper end portion of the small-diameter portion 32 is located above the upper surface of the second base body 21.

As shown in FIG. 2, the rolling bearing 40 is attached to the small-diameter portion 32. The rolling bearing 40 includes an inner race 41 and an outer race 42. The inner race 41 is externally fitted to the small-diameter portion 32 to be slidable in the axial direction. The outer race 42 includes a flange portion 42a which protrudes outward in the radial direction. The flange portion 42a is formed on the outer peripheral edge of the outer race 42 on an opposite side (that is, the upper side) to the first blade body 10. The outer race 42 is press-fitted into the bearing holding hole 23 of the second blade body 20. The lower surface of the flange portion 42a abuts on the upper surface of the second base body 21. The outer race 42 rotates integrally with the second blade body 20. The lower end edge of the rolling bearing 40 is located above the lower surface of the second base body 21.

A fixing member 50 is mounted on the support shaft 30 on the side opposite to the first blade body 10 across the rolling bearing 40 (that is, above the rolling bearing 40). The fixing member 50 is a nut member having a circular shape in a plan view screwed onto the male screw portion 33 of the support shaft 30. In the fixing member 50, an annular surrounding wall 51 extending downward from the outer peripheral edge portion thereof is formed. The lower end edge of the surrounding wall 51 is slightly spaced apart from the upper surface of the second base body 21. The surrounding wall 51 surrounds the upper end portion of the rolling bearing 40 from the outside in the radial direction.

A biasing member 60 is disposed between the rolling bearing 40 and the fixing member 50. The biasing member 60 is a disc spring. The inner peripheral edge of the biasing member 60 abuts on the upper end edge of the inner race 41 of the rolling bearing 40 from the upper side. The outer peripheral edge of the biasing member 60 abuts on the lower surface of the fixing member 50 from the lower side. Therefore, the inner race 41 is biased toward the first blade body 10 with respect to the fixing member 50 by the biasing member 60. Furthermore, as the inner race 41 is biased toward the first blade body 10, the rolling bearing 40 presses the second blade body 20 downward via the flange portion 42a of the outer race 42.

In this way, according to the present embodiment, one (the outer race 42 in the present embodiment) of the outer race 42 and the inner race 41 of the rolling bearing 40 rotates integrally with the second blade body 20, and the other (the inner race 41 in the present embodiment) is biased toward the first blade body 10 by the biasing member 60. Thus, the second blade body 20 can be pressed toward the first blade body 10. Therefore, the first blade body 10 and the second blade body 20 are always in pressure-contact with each other, and cutting performance can be maintained. In addition, since one of the outer race 42 and the inner race 41 rotating integrally with the second blade body 20 does not come into contact with the biasing member 60, it is possible to suppress an increase in the sliding friction at the time of rotation. Therefore, the movement of the first blade body 10 and the second blade body 20 can be made smooth. Therefore, it is possible to provide the scissors 1 capable of maintaining the excellent cutting performance.

Further, since the outer race 42 rotates integrally with the second blade body 20, the rolling bearing 40 and the second blade body 20 can be provided at the same axial position. Therefore, the structures of the rolling bearing 40 and the biasing member 60 can be simplified, the dimensions including those of the first blade body 10, the second blade body 20, and the rolling bearing 40 can be reduced in the axial direction, and the scissors 1 can be made thin.

Further, since the support shaft insertion hole 13 and the bearing holding hole 23 penetrate in the axial direction with a constant inner diameter, the first blade body 10 and the second blade body 20 can be manufactured at the same low cost as in conventional scissors.

Further, since the fixing member 50 surrounds the upper end portion of the rolling bearing 40 by the bottom surface thereof and the surrounding wall 51, entry of dust or the like can be suppressed. Thus, it is possible to suppress an increase in the rolling resistance of the rolling bearing 40 due to the entry of dust or the like. Therefore, the first blade body 10 and the second blade body 20 can be moved smoothly.

In the first embodiment, the support shaft 30 is press-fitted into the support shaft insertion hole 13, but the support shaft 30 may be fixed to the support shaft insertion hole 13 by adhesion or welding.

Further, in the first embodiment, the biasing member 60 is a disc spring, but the invention is not limited thereto, and the biasing member 60 may be, for example, a compression coil spring, a wave washer, or the like.

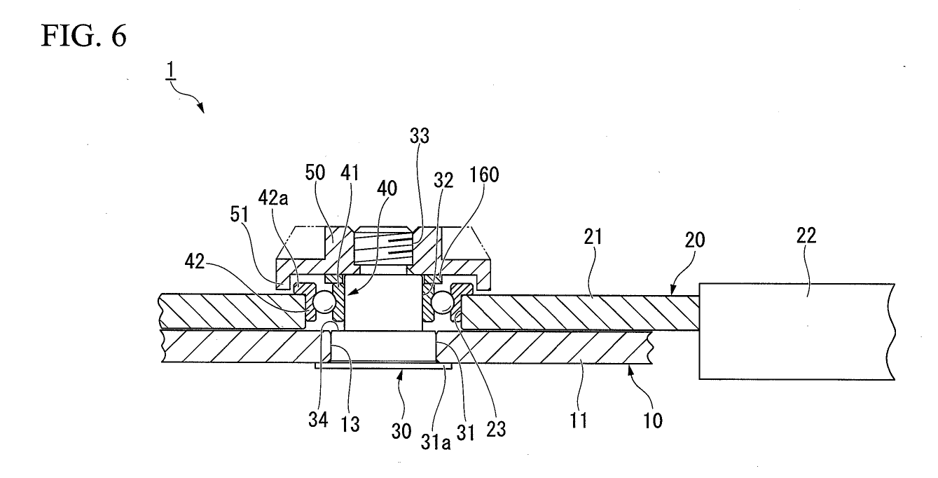

FIG. 6 is an explanatory view showing a modified example of the biasing member, and is a cross-sectional view of a portion corresponding to the line II-II of FIG. 1.

Further, as shown in FIG. 6, the inner race 41 of the rolling bearing 40 may be biased toward the first blade body 10 side by the annular biasing member 160 formed of an elastic material such as rubber, silicone rubber, or urethane.

### Second Embodiment

Next, scissors 101 of a second embodiment will be described.

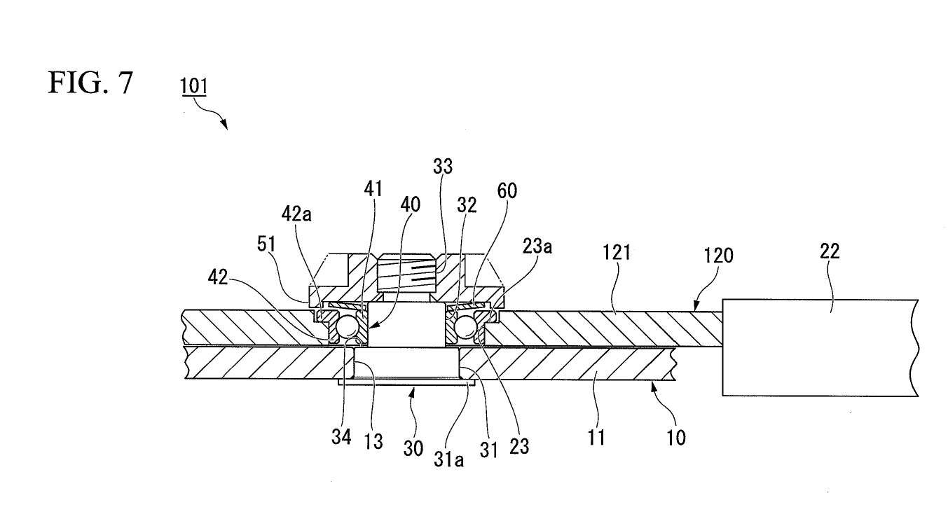

FIG. 7 is an explanatory view of the scissors according to the second embodiment, and is a cross-sectional view of a portion corresponding to the line II-II of FIG. 1.

In the first embodiment shown in FIG. 2, the bearing holding hole 23 of the second blade body 20 penetrates in the axial direction with a constant inner diameter. In contrast, the second embodiment shown in FIG. 7 differs from the first embodiment in that a counterbore portion 23a is formed at the upper end portion of the bearing holding hole 23 of the second blade body 120. Further, the same configurations as those in the above-described embodiment are denoted by the same reference numerals, and the detailed description thereof will not be provided (the same applies to each of the following embodiments).

As shown in FIG. 7, the counterbore portion 23a receives the flange portion 42a of the rolling bearing 40. The upper surface of the flange portion 42a is flush with the upper surface of the second base body 121 of the second blade body 120. The lower end edge of the rolling bearing 40 is disposed at the same axial position as the lower surface of the second base body 121.

According to the present embodiment, the outer race 42 has a flange portion 42a protruding outward in the radial direction, and the bearing holding hole 23 of the second blade body 120 is formed with a counterbore portion 23a which receives the flange portion 42a. Thus, by regulating the displacement of the rolling bearing 40 toward the first blade body 10 side by the abutment between the flange portion 42a and the counterbore portion 23a, the second blade body 120 can be pressed by the biasing member 60. Further, as the counterbore portion 23a receives the flange portion 42a, the dimension including the second blade body 120 and the rolling bearing 40 in the axial direction can be reduced. Therefore, the scissors 101 can be made thin.

### Third Embodiment

Next, scissors 201 of a third embodiment will be described.

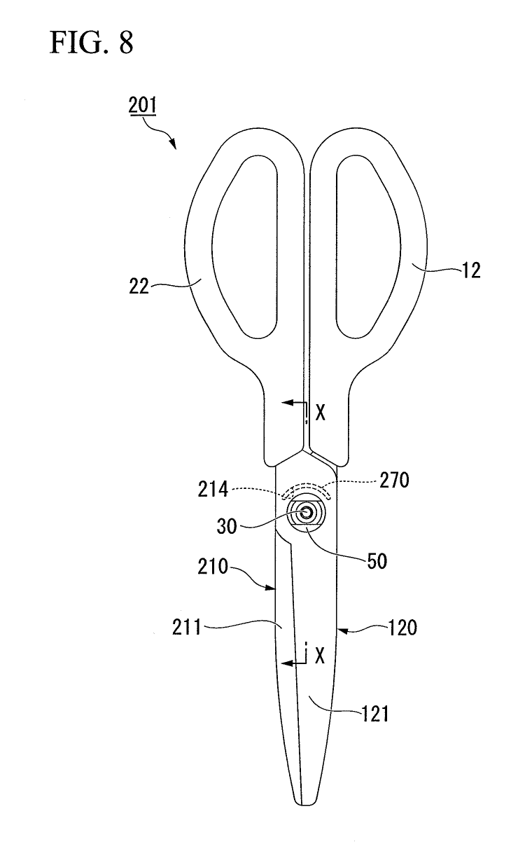

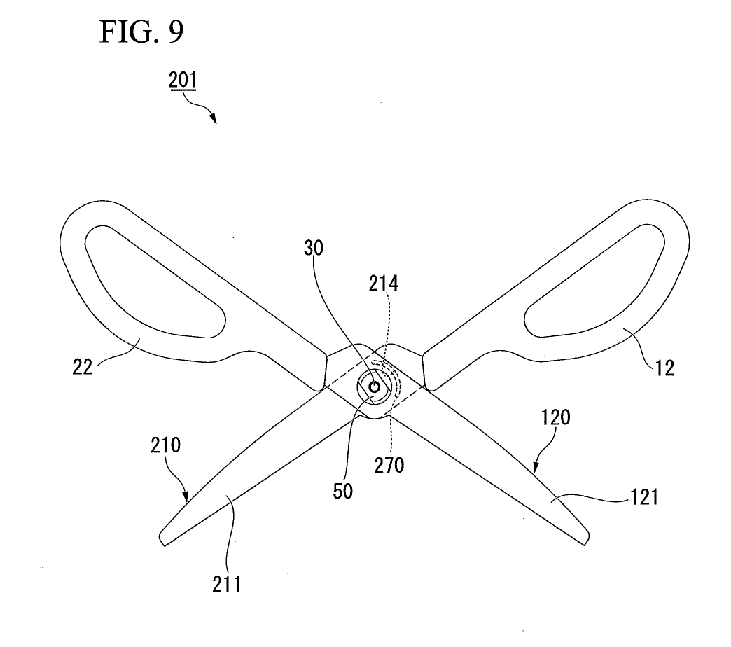

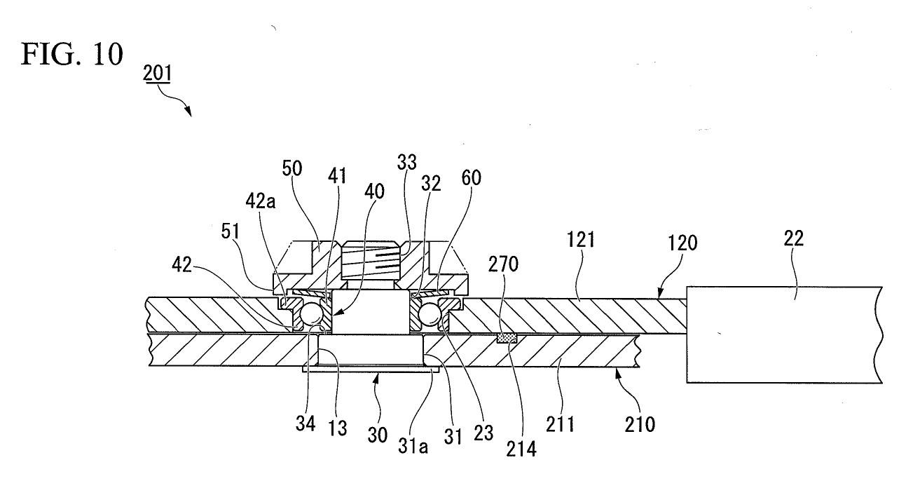

FIG. 8 is a plan view of the scissors according to the third embodiment in a closed state. FIG. 9 is a plan view of the scissors according to the third embodiment in an open state. FIG. 10 is a cross-sectional view taken along a line X-X of FIG. 8.

In the second embodiment shown in FIG. 7, the first blade body 10 and the second blade body 120 directly overlap each other. In contrast, the third embodiment shown in FIGS. 8 to 10 differs from the second embodiment in that a sliding member 270 is provided between the first blade body 210 and the second blade body 120.

As shown in FIGS. 8 to 10, the scissors 201 include a sliding member 270. The sliding member 270 is provided on the first blade body 210 and the second blade body 120 on the side closer to the proximal end side than the support shaft 30, at a position in which the first blade body 210 and the second blade body 120 always face each other. The sliding member 270 is formed to extend along the circumferential direction around the support shaft 30 as viewed from the axial direction. As shown in FIG. 10, the sliding member 270 is disposed in a housing groove 214 formed on the upper surface of the first base body 211 of the first blade body 210. The housing groove 214 is formed to correspond to the shape of the sliding member 270. The upper surface of the sliding member 270 abuts on the lower surface of the second base body 121 of the second blade body 120. The sliding member 270 biases the first blade body 210 and the second blade body 120 in the direction of being spaced apart from each other.

According to the present embodiment, since the sliding member 270 is provided at a position in which the first blade body 210 and the second blade body 120 always face each other, it is possible to reduce the sliding resistance between the first blade body 210 and the second blade body 120. Therefore, the movement of the first blade body 210 and the second blade body 120 can be made smooth.

Further, the sliding member 270 is provided on the first blade body 210 and the second blade body 120 on the side closer to the proximal end side than the support shaft 30 to bias the first blade body 210 and the second blade body 120 in the direction of being spaced apart from each other. Thus, the distal end sides of the first blade body 210 and the second blade body 120 can be brought close to each other with the support shaft 30 as a fulcrum. Accordingly, the blade lines provided on the distal end sides of the first blade body 210 and the second blade body 120 can be always pressed against each other, and the cutting performance can be improved.

### Fourth Embodiment

Next, the scissors 301 of the fourth embodiment will be described.

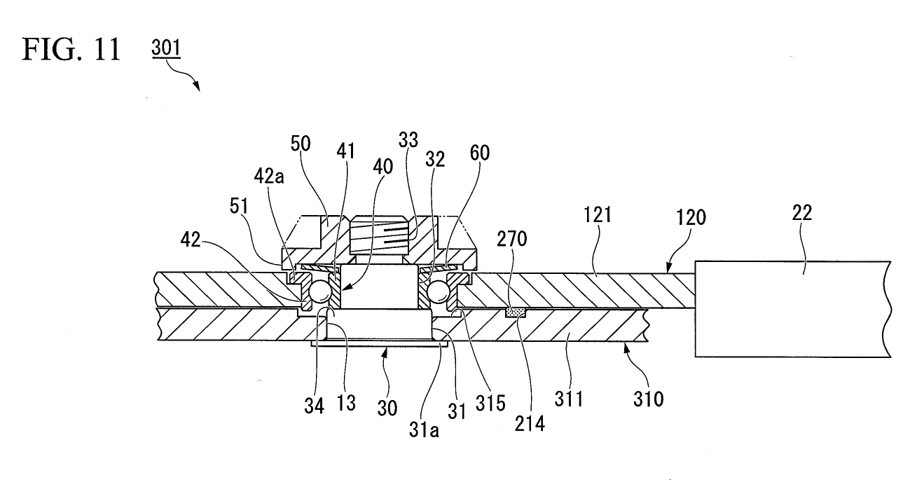

FIG. 11 is an explanatory view of the scissors according to the fourth embodiment, and is a cross-sectional view of a portion corresponding to the line X-X of FIG. 8.

In the third embodiment shown in FIG. 10, the lower end edge of the rolling bearing 40 is disposed at the same axial position as the lower surface of the second base body 121 of the second blade body 120. In contrast, the fourth embodiment shown in FIG. 11 is different from the third embodiment in that the lower end edge of the rolling bearing 40 is located below the lower surface of the second base body 121 of the second blade body 120.

As shown in FIG. 11, the lower end portion (the end portion on the side of the first blade body 310 in the axial direction) of the rolling bearing 40 protrudes downward from the lower surface of the second base body 121 of the second blade body 120.

On the upper surface of the first base body 311 of the first blade body 310, a recess 315 opening upward is formed. The recess 315 receives the lower end portion of the rolling bearing 40. The recess 315 is formed in a circular shape when viewed from the axial direction and is disposed coaxially with the support shaft insertion hole 13.

According to the present embodiment, since the recess 315 which receives the lower end portion of the rolling bearing 40 is formed on the upper surface of the first blade body 310, even when the lower end portion of the rolling bearing 40 protrudes from the second blade body 120 due to the thinning of the second blade body 120, the first blade body 310 and the second blade body 120 can be made overlap each other. Therefore, the scissors 301 can be made thin. Further, since the rolling bearing 40 can be increased in dimension without increasing the thickness of the scissors 301, the first blade body 310 and the second blade body 120 can be more smoothly moved.

### Fifth Embodiment

Next, scissors 401 of a fifth embodiment will be described.

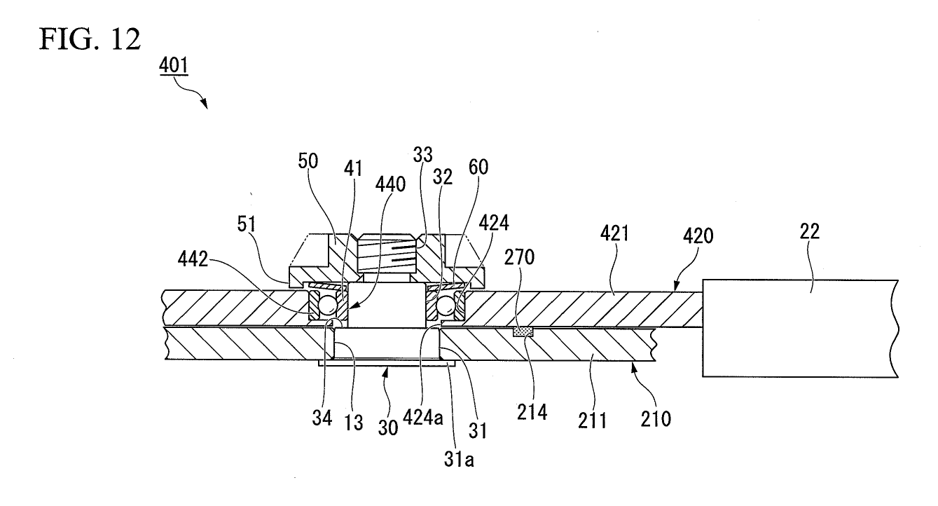

FIG. 12 is an explanatory view of the scissors according to a fifth embodiment, and is a cross-sectional view of a portion corresponding to the line X-X of FIG. 8.

In the third embodiment shown in FIG. 10, the outer race 42 of the rolling bearing 40 has the flange portion 42a. In contrast, the fifth embodiment shown in FIG. 12 is different from the third embodiment in that an outer race 442 of a rolling bearing 440 is formed uniformly along the axial direction.

As shown in FIG. 12, the scissors 401 have the rolling bearing 440. The rolling bearing 440 includes an inner race 41 and an outer race 442. The outer peripheral surface of the outer race 442 is uniformly formed along the axial direction.

A bearing holding recess 424 into which the outer race 442 is press-fitted is formed on the second base body 421 of the second blade body 420. The bearing holding recess 424 opens toward the fixing member 50 side (that is, the upper side) in the axial direction. The dimension of the bearing holding recess 424 in the axial direction is set to be equal to or larger than the dimension of the rolling bearing 440 in the axial direction. A through-hole 424a through which the support shaft 30 is inserted is formed in the bottom portion of the bearing holding recess 424. The inner diameter of the through-hole 424a is larger than the outer diameter of the inner race 41. The lower end edge of the outer race 442 abuts against the bottom surface of the bearing holding recess 424 from above. The bottom portion of the bearing holding recess 424 regulates the downward displacement of the rolling bearing 440.

According to the present embodiment, since the dimension of the bearing holding recess 424 in the axial direction is equal to or larger than the dimension of the rolling bearing 440 in the axial direction, by causing the rolling bearing 440 to abut against the bottom portion of the bearing holding recess 424, it is possible to completely house the rolling bearing 440 in the bearing holding recess 424, while enabling the second blade body 420 to be pressed by the biasing member 60, by restricting the displacement of the rolling bearing 440 toward the first blade body 210. As a result, it is possible to reduce the dimension including the second blade body 420 and the rolling bearing 440 in the axial direction. Therefore, the scissors 401 can be made thin.

### Sixth Embodiment

Next, scissors 501 of the sixth embodiment will be described.

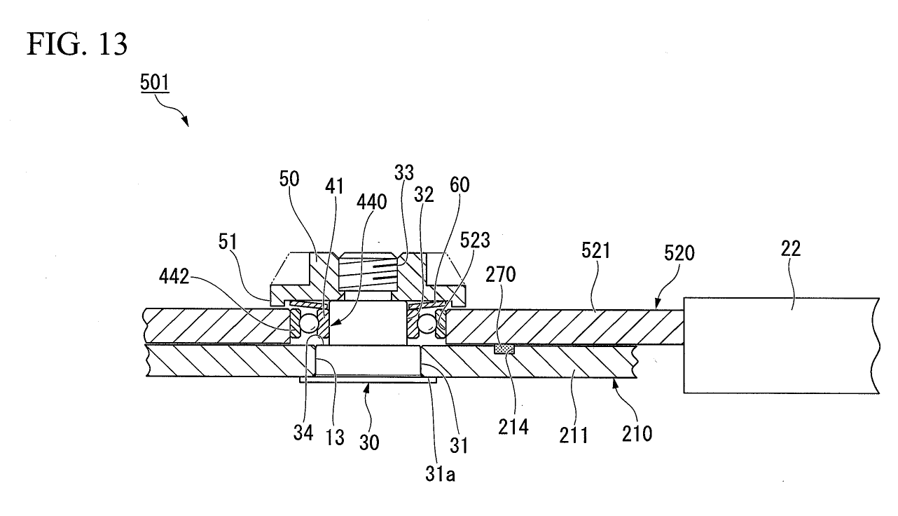

FIG. 13 is an explanatory view of the scissors according to the sixth embodiment, and is a cross-sectional view of a portion corresponding to the line X-X of FIG. 8.

In the fifth embodiment shown in FIG. 12, a rolling bearing 440 is mounted in the bearing holding recess 424 of the second blade body 420. In contrast, the sixth embodiment shown in FIG. 13 is different from the fifth embodiment in that the rolling bearing 440 is mounted to a bearing holding hole 523 uniformly formed along the axial direction on the second base body 521 of the second blade body 520.

As shown in FIG. 13, the outer race 442 of the rolling bearing 440 is fixed to the bearing holding hole 523. The outer race 442 is fixed to the bearing holding hole 523 by being press-fitted into the bearing holding hole 523. The outer race 442 may be fixed to the bearing holding hole 523 by welding, adhesion, or the like.

According to the present embodiment, since the bearing holding hole 523 is formed uniformly along the axial direction, the bearing holding hole 523 can be easily formed by press-machining or the like. Therefore, the second blade body 520 can be manufactured at low cost. Moreover, since the outer race 442 of the rolling bearing 440 is fixed to the bearing holding hole 523, the second blade body 520 can be pressed by the biasing member 60 by regulating the displacement of the rolling bearing 440 toward the first blade body 210 side, while preventing the rolling bearing 440 from falling out of the bearing holding hole 523. Therefore, the scissors 501 capable of maintaining excellent cutting performance can be provided at low cost.

### Seventh Embodiment

Next, scissors 601 of the seventh embodiment will be described.

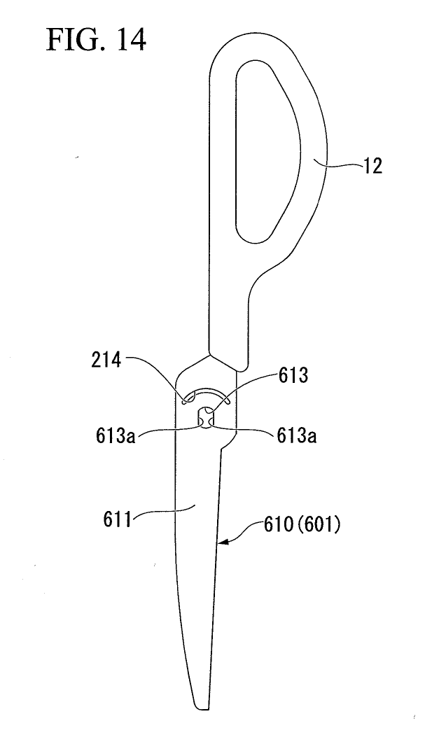

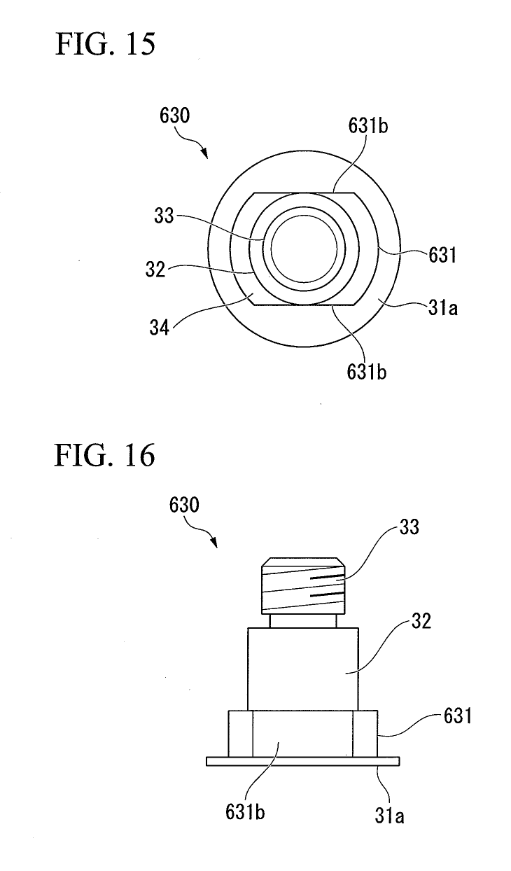

FIG. 14 is a plan view of the first blade body of the scissors according to the seventh embodiment. FIG. 15 is a plan view of the support shaft of scissors according to the seventh embodiment. FIG. 16 is a side view of the support shaft of scissors according to the seventh embodiment.

In the first embodiment shown in FIG. 3, the support shaft insertion hole 13 is formed in a circular shape in a cross-sectional view. In contrast, the seventh embodiment shown in FIG. 14 differs from the first embodiment in that a support shaft insertion hole 613 is formed in a non-circular shape (different shape) in a cross-sectional view. Further, in the first embodiment shown in FIG. 5, the large-diameter portion 31 of the support shaft 30 is formed in a circular shape in a cross-sectional view. In contrast, the seventh embodiment shown in FIG. 15 is different from the first embodiment in that a large-diameter portion 631 of the support shaft 630 is formed in a non-circular shape (different shape) in a cross-sectional view.

As shown in FIG. 14, on the inner peripheral surface of the support shaft insertion hole 613 in the first base body 611 of the first blade body 610, a pair of two-way chamfered surfaces 613 a (rotation stop portions) facing each other is formed.

As shown in FIGS. 15 and 16, the support shaft 630 includes a large-diameter portion 631 fitted to the support shaft insertion hole 613 (see FIG. 14). The large-diameter portion 631 is formed in a cylindrical shape, and a two-way chamfered portion 631b (rotation stop portion) is formed on both sides in a predetermined radial direction orthogonal to the axial direction. As shown in FIGS. 14 and 15, the two-way chamfered portion 631b is formed in a shape corresponding to the two-way chamfered surface 613a of the support shaft insertion hole 613. As a result, the two-way chamfered surface 613a and the two-way chamfered portion 631b prevent the first blade body 610 and the support shaft 630 from relatively rotating. The support shaft 630 is attachable to and detachable from the first blade body 610, and is press-fitted in a state in which a relative rotation is impossible.

According to the present embodiment, when the fixing member 50 (see FIG. 2) is mounted to the support shaft 630 while supporting the first blade body 610, it is possible to prevent the support shaft 630 from rotating with respect to the first blade body 610, by the two-way chamfered surface 613a and the two-way chamfered portion 631b which can prevent the first blade body 610 and the support shaft 630 from relatively rotating. Therefore, the fixing member 50 can be easily attached to and detached from the support shaft 630, and disassembling and assembling of the first blade body 610 and the second blade body 20 (see FIG. 2) can be easily performed.

Further, in this embodiment, by two-way chamfering (two chamfering) the support shaft insertion hole 613 and the support shaft 630, the first blade body 610 and the support shaft 630 can be disassembled and can be prevented from relatively rotating. However, the invention is not limited thereto. The first blade body and the support shaft may be disassembled from each other and may be prevented from relatively rotating, and these connection positions may be formed in a non-circular shape such as a polygonal shape when viewed from the axial direction. Further, the first blade body and the support shaft may be prevented from relatively rotating by a rotation stop portion such as a pin.

### Eighth Embodiment

Next, scissors 701 of the eighth embodiment will be described.

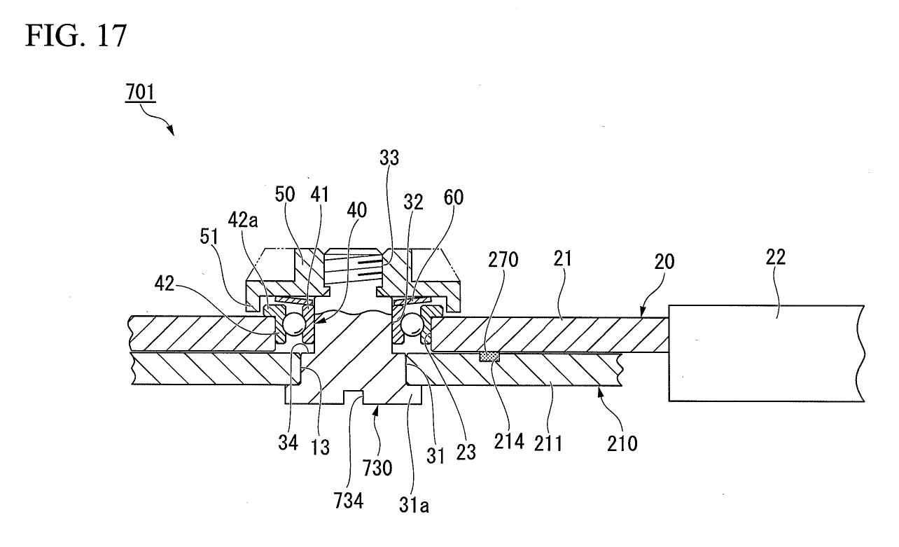

FIG. 17 is an explanatory view of the scissors according to the eighth embodiment, and is a cross-sectional view of a portion corresponding to the line II-II of FIG. 1.

In the first embodiment shown in FIG. 2, the lower end surface of the support shaft 30 is formed in a planar shape. In contrast, the eighth embodiment shown in FIG. 17 is different from the first embodiment in that a groove 734 extending along the direction orthogonal to the axial direction is formed on the lower end surface (the end surface on the first blade body 210 side in the axial direction) of the support shaft 730.

According to the present embodiment, since the groove 734 is formed on the lower end surface of the support shaft 730, it is possible to fix the support shaft 730 by inserting a driver or the like into the groove 734. Thus, the fixing member 50 can be easily attached to and detached from the support shaft 730, and disassembling or assembling of the first blade body 210 and the second blade body 20 can be easily performed.

It should be noted that the present invention is not limited to the embodiments described with reference to the drawings, and various modifications are conceivable within the technical scope thereof.

For example, in each of the above embodiments, the scissors are described as an example of the cutting device as an example, but the present invention is not limited thereto, and the cutting device may be, for example, a cutter.

Further, in each of the above embodiments, the rolling bearing is press-fitted into the bearing holding hole or the bearing holding recess of the second blade body, but the present invention is not limited thereto, and the outer race of the rolling bearing may be fixed to the second blade body.

Further, in each of the above embodiments, the fixing member is a nut member screwed to the upper end portion (male screw portion) of the support shaft. However, the present invention is not limited thereto, and the fixing member may be a caulking portion provided by bucking deformation of the upper end portion of the support shaft.

Furthermore, it is possible to substitute the constituent elements in the above-described embodiment with well-known constituent elements within a scope that does not depart from the gist of the present invention.

### INDUSTRIAL APPLICABILITY

According to the cutting device of each of the above embodiments, since one of an outer race and an inner race of a rolling bearing rotates together with a second blade body, and the other is biased toward a first blade body by the biasing member, the second blade body can be pressed toward the first blade body. For this reason, the first blade body and the second blade body are always brought into pressure-contact with each other, and the cutting performance can be maintained. In addition, since one of the outer race and the inner race that rotates integrally with the second blade body does not come into contact with the biasing member, an increase in sliding friction at the time of rotation can be suppressed. Therefore, the movement of the first blade body and the second blade body can be made smooth. Further, the same effect can be obtained in the scissors equipped with the cutting device.

Therefore, according to each of the above aspects of the present invention, it is possible to provide a cutting device and scissors capable of maintaining excellent cutting performance.

### REFERENCE SIGNS LIST

1, 101, 201, 301, 401, 501, 601, 701 Scissors (cutting device)
10, 210, 310, 610 First blade body
12 First gripping portion
20, 120, 420, 520 Second blade body
22 Second gripping portion
23, 523 Bearing holding hole
23a Counterbore portion
30, 630, 730 Support shaft
40,440 Rolling bearing
41 Inner race
42, 442 Outer race
42a Flange portion
50 Fixing member
60, 160 Biasing member
270 Sliding member
315 Recess
613a Two-way chamfered surface (rotation stop portion)
631b Two-way chamfered portion (rotation stop portion)
734 Groove

1. A cutting device comprising:
a support shaft;
a first blade body which holds the support shaft;
a rolling bearing which is mounted on the support shaft, and has an outer race and an inner race;
a second blade body which is provided to overlap the first blade body, and is rotatably supported on the support shaft via the rolling bearing;
a fixing member which is disposed on the support shaft on a side opposite to the first blade body across the rolling bearing; and
a biasing member disposed between the rolling bearing and the fixing member,
wherein one of the outer race and the inner race rotates integrally with the second blade body, and
the other of the outer race and the inner race is biased toward the first blade body by the biasing member.

2. The cutting device, according to claim 1, wherein the outer race rotates integrally with the second blade body, and
the inner race is biased toward the first blade body by the biasing member.

3. The cutting device according to claim 2, wherein the second blade body includes a bearing holding hole, the outer race being fixed to the bearing holding hole,
the outer race includes a flange portion protruding outward in a radial direction on an outer peripheral edge of the outer race opposite to the first blade body, and
a counterbore portion which receives the flange portion is formed on the bearing holding hole.

4. The cutting device according to claim 3, wherein one end portion of the rolling bearing on the first blade body side in the axial direction of the support shaft protrudes from a surface of the second blade body facing the first blade body toward the first blade body, and
on a surface of the first blade body facing the second blade body, a recess is formed which is open to the second blade body in the axial direction to receive the one end portion of the rolling bearing.

5. The cutting device according to claim 2, wherein the outer peripheral surface of the outer race is uniformly formed in the axial direction of the support shaft,
the second blade body includes a bearing holding recess which is open to the fixing member side in the axial direction, the outer race being fixed to the bearing holding recess, and
a dimension of the bearing holding recess in the axial direction is equal to or larger than a dimension of the rolling bearing in the axial direction.

6. The cutting device according to claim 2, wherein the outer peripheral surface of the outer race is uniformly formed in the axial direction of the support shaft,
the second blade body includes a bearing holding hole, the outer race being fixed to the bearing holding hole, and
the bearing holding hole is uniformly formed in the axial direction.

7. The cutting device according to claim 1, wherein a sliding member is provided at a position where the first blade body and the second blade body always face each other.

8. The cutting device according to claim 7, wherein the sliding member is provided on the first blade body and the second blade body on a side closer to a proximal end than the support shaft, and biases the first blade body and the second blade body away from each other.

9. The cutting device according to claim 1, wherein a rotation stop portion is provided on at least one of the first blade body and the support shaft to prevent relative rotation between the first blade body and the support shaft.

10. The cutting device according to claim 1, wherein a groove is formed on an end surface of the support shaft on the side of first blade body in the axial direction of the support shaft.

11. Scissors comprising:
the cutting device according to claim 1;
a first gripping portion provided on the proximal end side of the first blade body; and
a second gripping portion provided on the proximal end side of the second blade body.
